(19) United States
(12) Patent Application Publication
(10) Pub. No.: US 2015/0251655 A1
(43) Pub. Date: Sep. 10, 2015

(54) METHOD AND DEVICE FOR ESTIMATING THE DISTANCE BETWEEN A MOVING VEHICLE AND AN OBJECT

(71) Applicant: FORD GLOBAL TECHNOLOGIES, LLC, Dearborn, MI (US)

(72) Inventors: Mohsen LAKEHAL-AYAT, Aachen NRW (DE); Jitendra SHAH, Kolkata (IN); Ahmed BENMIMOUN, Aachen NRW (DE)

(21) Appl. No.: 14/643,796

(22) Filed: Mar. 10, 2015

(30) Foreign Application Priority Data
Mar. 10, 2014 (DE) 10 2014 204 360.3

(51) Int. Cl. B60W 30/08; G06T 7/00; H04N 7/18

(52) U.S. Cl. CPC B60W 30/08; H04N 7/183; G06T 7/004; G06T 2207/10004; G06T 2207/30261; G06T 2215/16; B60W 2550/30; B60W 2550/10

(57) ABSTRACT

A method generates at least two individual images of an object using a camera at different times, and estimates a distance from the object in an image registration method and on the basis of a scaling (s(t)) between these individual images. The scaling (s(t)) between the individual images is estimated using a frequency domain analysis.

### CROSS-REFERENCE TO RELATED APPLICATION

This application claims foreign priority benefits under 35 U.S.C. §119(a)-(d) to DE 10 2014 204 360.3, filed Mar. 10, 2014, which is hereby incorporated by reference in its entirety.

### TECHNICAL FIELD

This disclosure relates to a method and device for estimating the distance between a moving vehicle and an object. The estimation may advantageously be used in particular in conjunction with a system for automatic emergency braking or else with a system for adaptive speed regulation.

### BACKGROUND

Systems such as automatic emergency braking, which automatically brake a motor vehicle in order to avoid or reduce the effect of a traffic accident or a collision can, in principle, contribute to reducing the rate of traffic accidents and possibly reducing the amount of damage caused by accidents. However, this may require a real-time measurement of the distance between the moving motor vehicle and the respective object or obstacle.

Various approaches are known for measuring the distance between a moving motor vehicle and an object or obstacle. Thus, for example, LIDAR systems are known, which emit laser pulses and detect the light scattered back from the object in order to establish the distance to the object. Here, the measured distance is a function of the time interval elapsed between the emission of the laser pulse and the detection thereof. However, this approach does not allow a determination of form and type of the object.

A further approach is based upon stereoscopic imaging or recording, wherein the distance to the relevant object is determined from the parallax between two images of the same situation, wherein these two images are recorded by means of two cameras aligned with respect to one another.

A further method is based on measuring the distance between a moving vehicle and an object using a monocular camera; however, this requires the complete and correct compensation of the camera movement (in respect of tilt or inclination angle, pitch angle, etc.) and the carriageway inclination.

### SUMMARY

It is an object to provide a method and a device for estimating the distance between a moving vehicle and an object, which enable an estimate which is as precise as possible using a simple and robust approach.

A method for estimating the distance between a moving vehicle and an object, wherein the vehicle includes a camera, comprises the following steps:
generating at least two individual images using the camera at different times; and
estimating the distance from the object in an image registration method and on the basis of the scaling (s(t)) between these individual images;
wherein the scaling (s(t)) between the individual images is estimated using a frequency domain analysis.

In particular, certain embodiments are based on the concept of establishing the distance between a moving motor vehicle and an object or obstacle on the basis of the scaling which is estimated using two successive images of the object.

Here, the distance to the object from the scaling (s(t)) can be estimated according to the relationship

$$Z ( t ) = \frac{s ( t )}{1 - s ( t )} \cdot {T}_{z} ( t ) , \qquad ( 1 )$$

where T_{z}(t) denotes the z-component of the translation vector T between successive individual images.

According to one embodiment, the scaling value is estimated using a Fourier-Mellin transform (FMT). In the following, this Fourier-Mellin transform is discussed briefly; it corresponds to a two-dimensional Fourier transform after a transform into logarithmic coordinates and a transform into polar coordinates.

In the Fourier-Mellin transform, the transform into logarithmic coordinates transforms a scaling in real space into a translation in the frequency domain. Moreover, as a result of the transform into polar coordinates, a rotation in real space is transformed into a translation in the frequency domain. Here, the embodiment makes use of the fact that the Fourier-Mellin transform is not only invariant in relation to translation but that, furthermore, changes in the rotation and in the scaling also respectively appear as an addition of a pure phase shift and an amplitude change proportional to the change in scaling.

The Fourier-Mellin transform of a function f, wherein this Fourier-Mellin transform is subsequently referred to as M_{f}, therefore emerges from a Fourier transform of the angle coordinate and a Mellin transform of the radial component as

$${M}_{f} ( u , v ) = \frac{1}{2 π} {\int }_{0}^{∞} {\int }_{0}^{2 π} f ( r , θ ) {r}^{- j u} {e}^{- j v θ} d θ \frac{d r}{r} , \qquad ( 2 )$$

where u is the Mellin transform parameter and v is the Fourier transform parameter.

Image registration (i.e. determining the parameters for aligning two images in image processing) constitutes a basic method in image processing when superposing two or more images. In the image registration method, the parameters t, S and R are determined, where R denotes the rotation matrix in the form

$$R = ( \begin{matrix}cos θ & - sin θ \\ sin θ & cos θ\end{matrix} ) , \qquad ( 3 )$$

S denotes a scaling matrix, representing scaling in the x- and y-direction, in the form

$$S = ( \begin{matrix}{s}_{x} & 0 \\ 0 & {s}_{y}\end{matrix} ) , \qquad ( 4 )$$

which, in the case of equal scaling along the axes reduces to a scaling factor, and t denotes the displacement or translation.

Displacement or translation t, rotation R and scaling S respectively have an equivalent in Fourier space. Fourier-based methods differ from other standard methods by virtue of the fact that an ideal correspondence is sought-after in the frequency domain. Here, the Fourier-based methods make use of the displacement theorem and the rotation theorem of the Fourier transform since these provide invariance in relation to translation, rotation and scaling. According to the displacement theorem, a positional change occurring in real space does not lead to a change in amplitude of the Fourier transform.

According to one embodiment, the time profile of the scaling value is smoothed, which, in particular, can be brought about using a Kalman filter.

In accordance with one embodiment, a monocular camera is used as a camera.

Here, there is a direct or immediate measurement of the variation in the light intensity and of the number of all pixels representing the relevant object in the generated camera images in at least two successive individual images (“frames”). The appropriate group of selected pixels is selected in such a way that these represent the relevant object in the generated image. The measured variation in the intensity can be smoothed using a suitable filter.

The calculation of the distance occurs in real time, wherein the nonlinear relationship between the distance between camera and object on the one hand and the change in the scaling in the object in two successive individual images is used at each point in time. The smoothed scaling value is then obtained using the variation in the intensity and the previously measured number of pixels.

There is, in particular, no need for a light source since the concept for calculating the distance is based on estimating the scaling of the relevant object, the distance of which is intended to be established, from two successive individual images. In other words, the distance to the relevant object is calculated or estimated purely from the established camera data (and on the basis of the scaling as an absolute value).

Here, the method is advantageous in that there is no need for exact compensation of the camera movement (in respect of tilt or inclination angle, pitch angle, etc.) and also in that there is no need for establishing the carriageway incline or carriageway drop.

Certain embodiments include a device for estimating the distance between a moving vehicle and an object, wherein the device is configured to carry out a method comprising the features described above. Further embodiments can be gathered from the description.

### BRIEF DESCRIPTION OF THE DRAWINGS

FIG. 1 shows a flowchart for explaining the progress of a method for estimating the distance.

### DETAILED DESCRIPTION

As required, detailed embodiments of the present invention are disclosed herein; however, it is to be understood that the disclosed embodiments are merely exemplary of the invention that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A monocular camera assembled on the vehicle is used for estimating the distance between a moving vehicle and an object, wherein the optical axis of the camera corresponds to the direction of the translational movement of the vehicle. The object may be a vehicle (which is at rest or likewise moving) or a standing or moving pedestrian, or another road user.

The calculation of the distance is then performed using the scaling s(t) established from “tracking” over a plurality of individual images recorded by the camera in accordance with equation (1) already mentioned above

$$Z ( t ) = \frac{s ( t )}{1 - s ( t )} \cdot {T}_{z} ( t ) . \qquad ( 1 )$$

Here, T_{z}(t) denotes the z-component of the translation vector T between successive individual images, which is established with the aid of inertial sensors. In principle, the pixel x=(x, y) corresponding to the projection of a point X=(X, Y, Z) lying in three-dimensional space emerges from the following

$$( \begin{matrix}x \\ y\end{matrix} ) = \frac{f}{Z} \cdot ( \begin{matrix}X \\ - Y\end{matrix} ) , \qquad ( 5 )$$

where f denotes the focal length of the camera. To a good approximation, the z-coordinate can be considered to be constant in the following since the variation thereof over the surface of the object or obstacle facing the camera is comparatively small relative to the distance between object and camera.

If the path belonging to a relative movement between camera and object occurring between the time t and the time t+Δt is denoted by T (t, Δt), the following emerges

X(t+Δt)=X(t)+T(t, Δt) (6)

In the case of a purely translational movement under consideration, the following result emerges for the transformation of a pixel

$$\begin{matrix}x ( t + Δ t ) = \frac{f}{Z ( t + Δ t )} ( \begin{matrix}X ( t + Δ t ) \\ - Y ( t + Δ t )\end{matrix} ) \\ = \frac{Z ( t )}{\underbrace{Z ( t ) + {T}_{Z} ( t )}} \underbrace{\frac{f}{Z ( t )} ( \begin{matrix}X ( t ) \\ - Y ( t )\end{matrix} )} + \frac{f}{Z ( t ) + {T}_{z} ( t , Δ t )} ( \begin{matrix}{T}_{X} ( t ) \\ - {T}_{Y} ( t )\end{matrix} )\end{matrix} \\ x ( t + Δ t ) = s ( t ) \cdot x ( t ) + \frac{1 - s ( t )}{{T}_{z} ( t )} \cdot f \cdot ( \begin{matrix}{T}_{X} ( t ) \\ - {T}_{Y} ( t )\end{matrix} ) . \qquad ( 7 )$$

Here, s(t) denotes the scaling between successive images at the time t.

The approach proceeds from the aforementioned equation (7), wherein it is possible to show that, under the given circumstances, the distance can be estimated purely on the basis of estimating the scaling factor of the object images. The image scaling s(t) and the translational image shifts between two successive individual images are estimated using the frequency domain analysis.

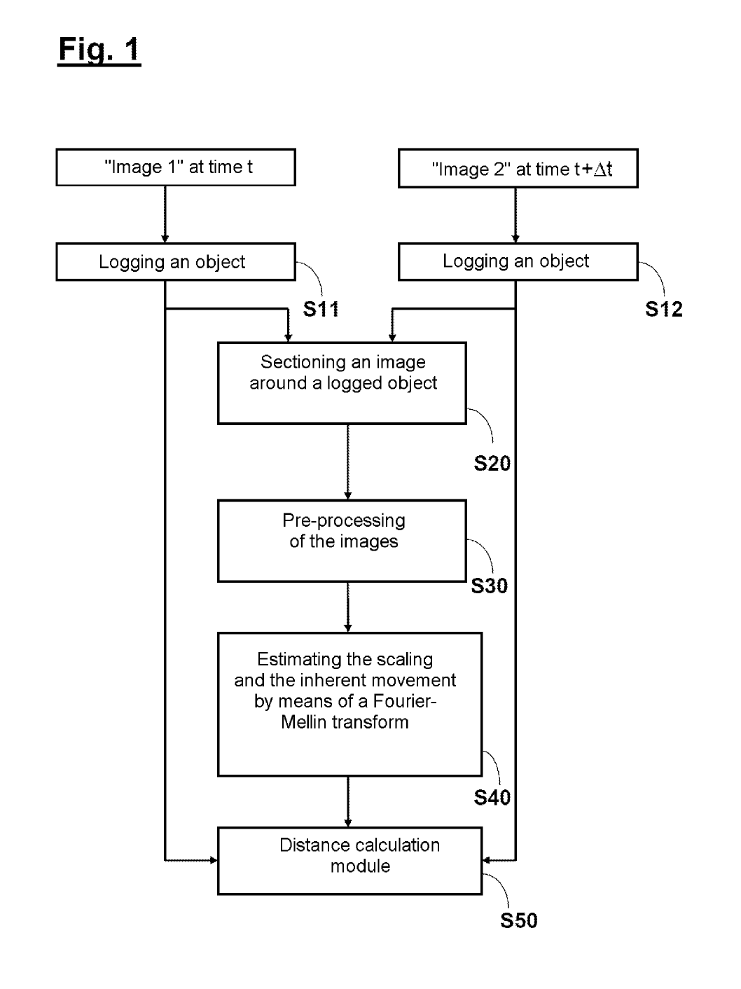

In accordance with FIG. 1, an object or obstacle is logged on the basis of an edge analysis in steps S11 and S12 using a first image (“image 1”) recorded at the time t and a second image (“image 2”) recorded at the time t+Δt. The images obtained thus (“region images”) are fed to an algorithm containing a Fourier-Mellin transform (FMT), wherein both the scaling s(t) and the components Tₓ(t) and T_{y}(t) of the translation vector are calculated. The z-component T_{z}(t) of the translation vector T_{z} between successive individual images is established with the aid of inertial sensors.

After the image sectioning undertaken in step S20 and after the preprocessing of the images in step S30, the scaling and the inherent movement are estimated in step S40 using a Fourier-Mellin transform and, on the basis of this estimate, a distance is calculated in step S50 in a distance calculation module, which is fed both the results from step S40 and the logging of the object or obstacle on the basis of the edge analysis from steps S11 and S12. Here, a Kalman filter can be used for smoothing the time profile of the scaling s(t).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for estimating distance between a moving vehicle and an object, wherein the vehicle includes a camera, the method comprising:
generating at least two individual images using the camera at different times; and
estimating the distance from the object in an image registration method and on a basis of a scaling (s(t)) between the individual images; wherein the scaling (s(t)) between the individual images is estimated using a frequency domain analysis.

2. The method of claim 1, wherein the scaling (s(t)) is estimated using a Fourier-Mellin transform.

3. The method of claim 1, wherein the distance from the object is estimated from the scaling (s(t)) in accordance with the relationship
$$Z ( t ) = \frac{s ( t )}{1 - s ( t )} \cdot {T}_{z} ( t ) ,$$
where T_{z}(t) denotes a z-component of the translation vector T between successive individual images.

4. The method of claim 1, wherein a time profile of the scaling (s(t)) is smoothed.

5. The method of claim 4, wherein a time profile of the scaling (s(t)) is smoothed using a Kalman filter.

6. The method of claim 1, wherein a monocular camera is used as a camera.

7. A vehicle comprising:
a camera; and
at least one processor programmed to provide output indicative of a distance between an object and the vehicle based on a scaling associated with two successive images of the object captured by the camera, wherein the scaling is based on transforms of a real space scaling and a real space rotation into frequency domain translations such that changes in the real space scaling and real space rotation affect a phase shift and amplitude of the frequency domain translations respectively.

8. The vehicle of claim 7, wherein the transforms of the real space scaling and the real space rotation into frequency domain translations are Fourier-Mellin transforms.

9. The vehicle of claim 7, wherein the at least one processor is further programmed to smooth a time profile of the scaling via a Kalman filter.

10. The vehicle of claim 7, wherein the camera is a monocular camera.

11. An image system for a vehicle comprising:
at least one processor programmed to provide output indicative of a distance between an object and the vehicle based on a scaling associated with two successive images of the object, wherein the scaling is based on transforms of a real space scaling and a real space rotation into frequency domain translations.

12. The image system of clam 11, wherein the transforms of the real space scaling and the real space rotation into frequency domain translations are Fourier-Mellin transforms.

13. The image system of claim 11, wherein the at least one processor is further programmed to smooth a time profile of the scaling via a Kalman filter.
